(19) United States
(12) Patent Application Publication
(10) Pub. No.: US 2019/0193263 A1
(43) Pub. Date: Jun. 27, 2019

(54) Single compact robotic food making apparatus

(71) Applicant: Sridhar Raidi, Irvine, CA (US)

(72) Inventor: Sridhar Raidi, Irvine, CA (US)

(21) Appl. No.: 15/965,991

(22) Filed: Apr. 30, 2018

(30) Foreign Application Priority Data
Dec. 22, 2017 (IN) 201741046214
Mar. 7, 2018 (IN) PCT/IN2018/000018

(51) Int. Cl. B25J 9/00; A47J 44/00; A47J 47/01; A23L 5/10; B25J 9/10

(52) U.S. Cl. CPC B25J 9/0081; A47J 44/00; B25J 9/102; A23L 5/10; A47J 47/01

(57) ABSTRACT

The present invention relates to a single compact robotic food making apparatus that can automatically record culinary dish cooking process as digital recipe and repeat cooking same culinary dish using the digital recorded recipe. The ingredients are loaded into carousel canisters, which are mounted next to heating apparatus. The apparatus includes memory card for storing one or more digital recipe. The digital recipe specifies schedules for dispensing the ingredients from the spice dispenser into carousel canister and from carousel canisters into a cooking utensil, for dispensing liquids, for heating the cooking utensil, for stirring the contents of the cooking utensil. These operations are performed automatically under the control of one or more processor module which is connected to network wirelessly. Cooking utensil and stirrer can be self-cleaned after the cooking process by dispensing cleaning material and water into the cooking utensil and stirring it.

### FIELD OF THE INVENTION

The present invention relates to the field of cooking apparatus for the household kitchen, and in particular to a compact appliance for cooking culinary dishes. More particularly, the invention relates to a robotic cooking apparatus which records culinary dish cooking process as digital recipe, and the apparatus can repeat cooking the same culinary dish using digital recipe.

### BACKGROUND OF THE INVENTION

Invention and use of devices to aid in food production is known to public. There are a number of automatic cooking devices existing, but they are very complicated for cooking a new culinary recipe by ordinary skilled user so that an appliance can cook. Existing automatic recipe cooking devices are bulky for home use and take a considerable floor or kitchen counter space. Some automatic cooking devices need separate kitchen to be custom made. Average home cannot accommodate these devices and they are very expensive. Furthermore, they are made for bulk production of food in restaurant setup. They are not designed to cook meals for average family size at home. Most of the existing automatic cooking devices are very labor and time intensive to clean.

In one of the prior art U.S. Pat. No. 4,649,810 titled “Automatic Cooking Apparatus” discloses a microcomputer-controlled, integrated cooking apparatus for automatically preparing culinary dishes. The constituent ingredients of a particular dish are loaded into a compartmentalized carousel, which is mounted on the cooking apparatus. The apparatus includes a memory for storing one or more recipe programs. The recipe program specifies schedules for dispensing the ingredients from the carousel into a cooking vessel, for heating the vessel (either covered or uncovered), and for stirring the contents of the vessel. These operations are performed automatically under control of the microcomputer.

In one of the prior art U.S. Pat. No. 4,922,435 titled “Food Preparation Robot” which discloses a fully automated robotized system and method is provided for cooking food products. The system and method is especially useful for use in a quick service or fast food restaurant and, in one embodiment, is capable of cooking, on a fully automated basis, French fries, chicken nuggets, fish filets and chicken patties. In one embodiment, the system includes a robot, a bulk uncooked food dispensing station, a cooking station and a cooked food storage station. The system can be controlled by a computer operating and control station that controls and directs the robot to obtain bulk food from the dispensing station, place it in cooking position at the cooking station and when cooked, remove the food and deliver it to the storage station, at a rate required to fill anticipated customer orders.

In another prior art U.S. Pat. No. 5,386,762 titled “Robotic Chef” discloses an automated food preparation system having a continuously rotatable annular segmented cooking area, a food feeding system, and an industrial robot, all of which are controlled by a pre-programmed programmable controller wherein an operator provides input to the programmable controller selecting each food item to be cooked and the programmable controller commands the industrial robot to select the food item, place the food item on the cooking area for cooking, turn the food item at the proper time, and remove the food item from the cooking area.

In yet another prior art U.S. Pat. No. 7,174,830 titled “Robotic Cooking System” discloses an automated system of preparing food designed with the preparation of Chinese food in mind, the system can be adapted to whatever type of food is desired by the user. The system uses one or more robots as the “chefs”. A heating element heats a cooking pan to a desired temperature. The cooking pan includes a temperature sensing element to monitor heating of the pan and cooking of the food. When the pan is fully heated, a delivery arm empties the contents of the bowl into the cooking pan to being the actual cooking. When the contents of the pan have reached the correct temperature to be “done”, the robot empties the contents into a serving dish, and the food is ready to be eaten.

In another prior art Chinese patent application number CN100588328C titled “Full Automatic cooking robot system” discloses a robot system capable of completing different kinds of kitcheneering affairs automatically by timing. The robot system comprises of an automatic multifunctional intellectualized subsystem integrated with washing vegetable, dishes, sterilization, storage and preservation; automatic multifunctional vegetable cutter subsystem; automatic intellectualized cooking and compounding subsystem and oil fume pumping system; automatic cooking subsystem; automatic rice cooking subsystem; intellectualized automatic cooking digital menu software controls subsystem. The system establishes an only recognition coding, specifically to a robot system applicable for common household kitchen, restaurant kitchen, logistics kitchen, and automatic snack service. The invention can save time spent on cooking affairs, reduce labor cost, save a great deal of social resource and money spent on cooking affair.

In yet another prior art Europe Patent Application number EP1532902 titled “Automatic food cooking apparatus” discloses an automatic cooking machine, especially one that can properly control the duration and degree of cooking of cooked materials and can automatically perform various main cooking techniques. The automatic cooking machine comprising a pan, a sensor system, an auto feeding system, an auto adjusting system for heating intensity by gas/electrical heating, an auto turnover system for the cooked materials, an auto taking-out system for the cooked materials and a computer control system. In the present invention, under the control of the computer control system, the sensor system directly detects the duration and degree of cooking of the cooked materials, the auto adjusting system for heating intensity automatically regulates heating power in a continuous manner or a multistage manner, the auto feeding system automatically feeds the cooking-material at the proper duration and degree of cooking, and the auto turnover/taking-out system for the cooked materials turns over and takes out the cooked materials at the proper moment under the requirements of cooking techniques. Therefore, the automatic cooking machine can perform various main cooking techniques, especially those for preparing Chinese dishes.

From the prior art it is understood that it is not easy to digitally record the recipe of the culinary dish while cooking. The present invention provides the user with the advantage of cooking a digital recipe by recording the cooking process, whereby the digital recorded recipe can be used to cook the same culinary dish again. Further, the recipe can be customized according to the user's preference. Furthermore the digital recipe can also be shared with other users of the invention thus preserving traditional cooking process in digital form.

Therefore, it can be summarized that, an advantage of the present invention is a single compact countertop device which is accommodatable in average homes and is easily movable.

Another advantage of the present invention is that, each of the canister mounted on the rotating arms are detachable, and they can be disposed if disposable canisters are used.

Another advantage is that, the canisters of the present invention can be easily cleaned if reusable canister is used and the cooking utensil and stirring member are cleaned automatically after emptying the cooking utensil and choosing the cleaning cycle. Further, the present invention does not require the presence of the user once the ingredients are loaded into the canister.

### Objective of the Invention

The primary objective of the present invention is to provide a single compact countertop automatic cooking device.

It is another objective of the present invention to provide easy cleaning of the said device.

It is yet another objective of the present invention to record the cooking process and save a digital recipe of the culinary process and by using the stored digital recipe, the same culinary dish can be cooked again in the future.

It is another objective of the present invention to share the digital recipe with other users to enable cooking the same recipe by others.

It is another objective of the present invention user should be able to change the digital recipe according to their preference.

It is further objective of the present invention to provide a user free automatic cooking device.

It is another objective of the present invention that allows the user the freedom of not measuring the quantity of dry ingredients needed for cooking a culinary dish, the cooking device automatically measures the quantity dry ingredients needed for a culinary dish and adds it to the cooking utensil.

It is still another objective of the present invention to do away with measuring the liquid ingredients of the recipe since the cooking device automatically pumps desired amount of liquid ingredients into the cooking utensil by using peristaltic pump.

It is further objective of the present invention to provide detachable canisters for easy cleaning as well as disposal.

### SUMMARY OF THE INVENTION

It will be understood that this disclosure is not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only and is not intended to limit the scope of the present disclosure.

The present invention is a single compact robotic food making apparatus that can automatically record culinary dish cooking process as digital recipe and repeat cooking the same culinary dish using the recorded digital recipe. The ingredients are loaded into carousel canisters, which are mounted next to heating apparatus. The apparatus includes memory card for storing one or more digital recipe. The digital recipe specifies schedules for dispensing the ingredients from the spice dispenser into carousel canister and from carousel canisters into a cooking utensil, for dispensing liquids, for heating the cooking utensil and for stirring the contents of the cooking utensil. These operations are performed automatically under the control of one or more processor module which is connected to network wirelessly. Cooking utensils and the stirrer can be self-cleaned after the completion of the cooking process by dispensing cleaning material and water into the cooking utensil and stirring it.

It is one aspect of the present invention, where the heating unit comprises of a sensor, which provides signals for heating the heating element only when a cooking utensil is placed over the said heating element.

It is another aspect of the present invention to provide at least one heating element, comprising of a temperature sensor which heats the cooking utensil to a desired temperature and turns off once the ingredients are cooked.

It is another aspect of the present invention to provide at least one carousel, wherein the carousel is mounted on top of one another and rotates independently on its own axis. The carousel is placed beside the heating element. The carousel rotates and positions the rotating arm close to the cooking utensil on the heating element.

It is yet another aspect of the present invention to provide at least one spice dispenser, wherein the dispenser is placed on top of the carousel and the spice dispenser dispenses the ingredients into the carousel canister.

It is a further aspect of the present invention to provide at least one liquid dispensing apparatus, wherein the apparatus comprises of a reservoir to store liquid, a sensor to determine the quantity of remaining liquid in the said reservoir and wherein, the liquid of the said liquid dispensing apparatus is oil, water or cleaning liquid.

It is also another aspect of the present invention to provide at least one stirring apparatus, comprising of a stirring member for stirring the ingredients in the cooking utensil.

It is yet another aspect of the present invention to provide at least one rotating arm, which is attached to the carousel and which empties the ingredients to the cooking utensil. The rotating arm dispenses the ingredients by rotating the canister attached to the arm, and the ingredients are dispensed into the cooking utensil.

It is another aspect of the present invention to provide at least one motor, for rotating the rotating arm.

It is one more aspect of the present invention to provide at least one sensor, for detecting the position of the rotating arm.

It is another aspect of the present invention to provide at least one canister, for attaching and detaching from the rotating arm.

It is yet another aspect of the present invention to provide at least one carousel canister, for placing below the canister. The carousel placed on top, transfers the ingredients from the canister to the carousel canister.

It is another aspect of the present invention to provide a process for recording all actions of the user in the form of digital recipe while cooking a new recipe and contains at least one weight measuring sensor, which measures the weight of the ingredients used during new culinary recipe cooking and recording process.

The apparatus of the present invention is controlled by one or more microcontroller, which are connected to a wireless network and is operated by means of user interface on the apparatus or handheld devices and monitored accordingly for recording recipes or new recipes.

### BRIEF DESCRIPTION OF DRAWINGS

For a more complete understanding of the present invention, reference is now made to the following descriptions taken in conjunction with the accompanying drawing, in which:

FIG. 1 illustrates an isometric view of the single compact robotic food making apparatus of the present invention.

FIG. 2 illustrates the various views of the rotating arm with canister of the present invention.

FIG. 3 illustrates a detailed isometric view of the carousel stand of the present invention.

FIG. 4 illustrates the top view of the apparatus of the present invention depicting liquid reservoirs, spice dispenser, stirring apparatus and stirring member.

FIG. 5 illustrates the top view of the rotation of the carousel of the present invention.

FIG. 6 illustrates of the dry material dispensing container dispensing dry material into carousel below it and carousel dispensing ingredients into the cooking utensil.

FIG. 7 illustrates the various parts of the spice dispenser.

FIG. 8 illustrates the detailed view of the integrated stirring and liquid dispensing apparatus.

FIG. 9 depicts the view of the user interface screen of the present invention.

FIGS. 10a and 10b illustrates the flow chart or the recipe cooking process and recipe recording process respectively of the present invention.

FIG. 11 illustrates an exemplary embodiment of the control unit of the single compact robotic food making apparatus.

### DETAILED DESCRIPTION OF THE INVENTION:

The following detailed description illustrates by way of example and not by way of limitations.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein.

In the disclosure herein, consideration or use of a particular element number in a given FIGURE or corresponding descriptive material can encompass the same, an equivalent, or an analogous element number identified in another FIGURE or descriptive material corresponding thereto. Some embodiments of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, apparatus is now described.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

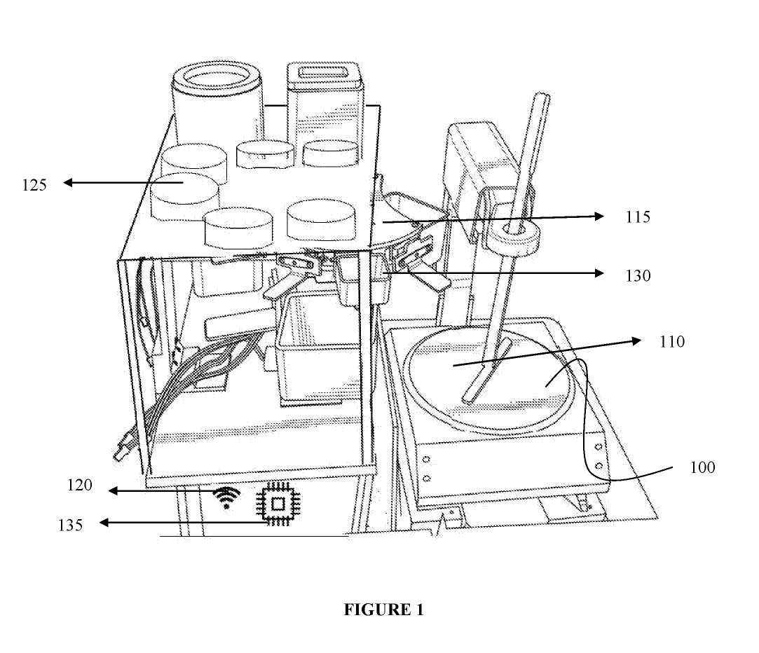

FIG. 1 illustrates an exemplary embodiment of a single compact robotic food making apparatus 100 comprising of a heating element 110, wherein the said heating element 110 comprises of a temperature sensor for monitoring the temperature of the cooking utensil placed on the heating unit and for heating the cooking utensil to a desired temperature and another sensor which determines the presence of the cooking utensil and commences the heating process only if the cooking utensil is present on the said heating element 110.

When the utensil is heated to desired temperature, a rotating arm empties the contents of the canister into the cooking utensil to begin the actual cooking. Once the contents of the utensil have reached the correct temperature, the heat is turned off automatically and utensil can be removed by the user from the heating element for serving.

The apparatus further comprises of one or more carousel 115 positioned beside the said heating element and stacked on top of each other and each said carousel 115 is rotated independently.

The said apparatus 100 further comprises of plurality of spice dispenser 125 positioned on the top most carousel 115 which dispenses the ingredients into a canister 130.

In an embodiment of the present invention, the said apparatus may also be operated using a wireless device wherein the said device comprises of a data transceiver 120 to communicate with the cooking apparatus wherein the said data transceiver receives and sends data to the said cooking apparatus.

The apparatus further comprises of a processor module 135, wherein the said module comprises of software to control, operate all units and sensors and store the digital recipe. The said processor module is capable of connecting to network by means of wire or wirelessly.

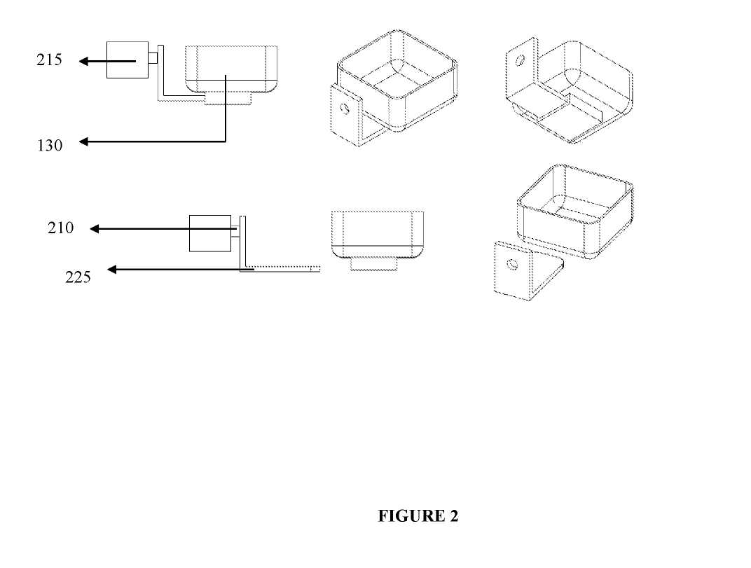

FIG. 2 illustrates an exemplary embodiment of the carousel 115 comprising of a rotating arm having a vertical bar 210 which in turn is connected with a horizontal bar 225. The said vertical bar 210 of the rotating arm is connected to a motor 215, adapted for rotating the said rotating arm 210. At least one said canister 130 is filled with ingredients and can be attached and detached from the said rotating arm 210. At least one sensor configured on the said carousel 115 for detecting the position of the rotating arm 210.

The said carousel 115 rotates and positions the said rotating arm 210 close to the cooking utensil placed on the said heating element 110. The said rotating arm 210 dispenses ingredients by rotating the canister 130 attached to the arm 225, and the ingredients are dispensed directly into the cooking utensil. Multiple carousels 115 are stacked on top of each other.

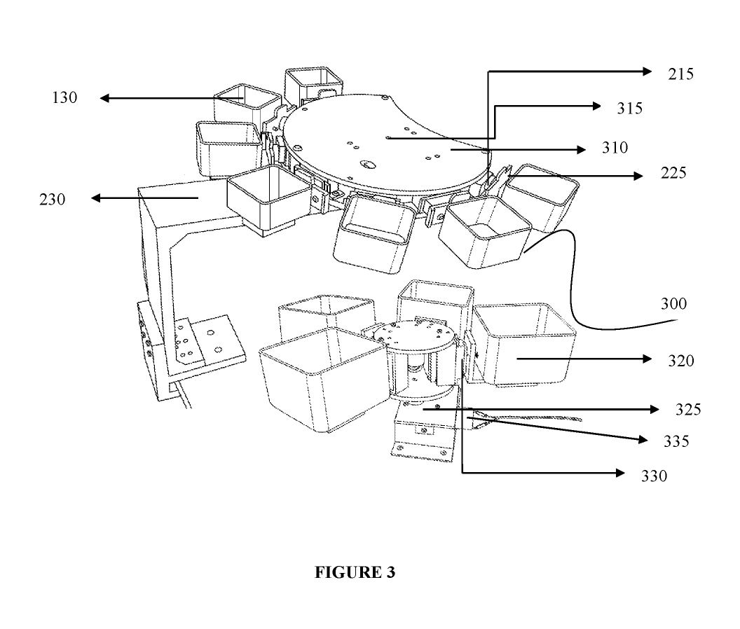

FIG. 3 illustrates the exemplary embodiment of the carousel stand 300 wherein the said stand comprises of plurality of canister 130. The canister 130 is attached by means of an arm 225. The canister 130 is rotated by means of a motor 215, wherein the said motor 215 rotates the arm 225 which is attached to the canister 130. The above mentioned parts are attached by means of the said stand (230 ).

The said carousel stand 300 comprises of a carousel case 310 wherein the motors and electronics are attached. The said carousel case 310 comprises of a carousel axis 315 for rotation wherein the said carousel axis comprises of a motor 335 present at the bottom of the said carousel case 310 to rotate the carousel 115. The carousel 115 located on the top transfers ingredients from its canister 130 into the carousel canister 320 positioned directly below.

The said canister can be of different sizes (130 and 320 ). The said larger canister 320 is attached by means of a lower carousel stand 325 and a motor 330, and the said larger canister 320 is rotated by means of the said motor 330.

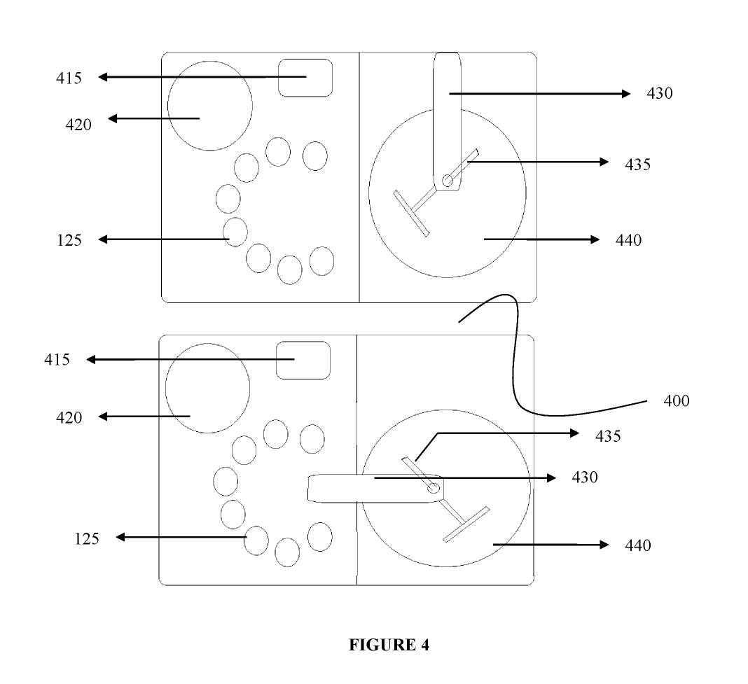

FIG. 4 illustrates the top view of the apparatus depicting liquid reservoirs a first liquid reservoir 415 and a second liquid reservoir 420, spice dispenser (125 ), stirring apparatus 430 and stirring member 435.

The said apparatus comprises of a liquid dispensing apparatus with a first liquid reservoir 415 and a second liquid reservoir 420 for storing the liquid. The said first liquid reservoir 415 and a second liquid reservoir 420 also comprises a sensor for determining the quantity of liquid in the said reservoir 415 and 420.

As detailed above, a plurality of spice dispensers 125 positioned at the top most carousel 115 dispenses the ingredients into the said canister 130.

As mentioned above, the said stirring apparatus 430 is provided with a stirring member 435 for stirring the contents of the cooking utensil 440.

The said stirring apparatus 430 rotates the said stirring member 435 clockwise and anticlockwise, thus, accomplishing stirring of the contents of the cooking utensil 440 completely.

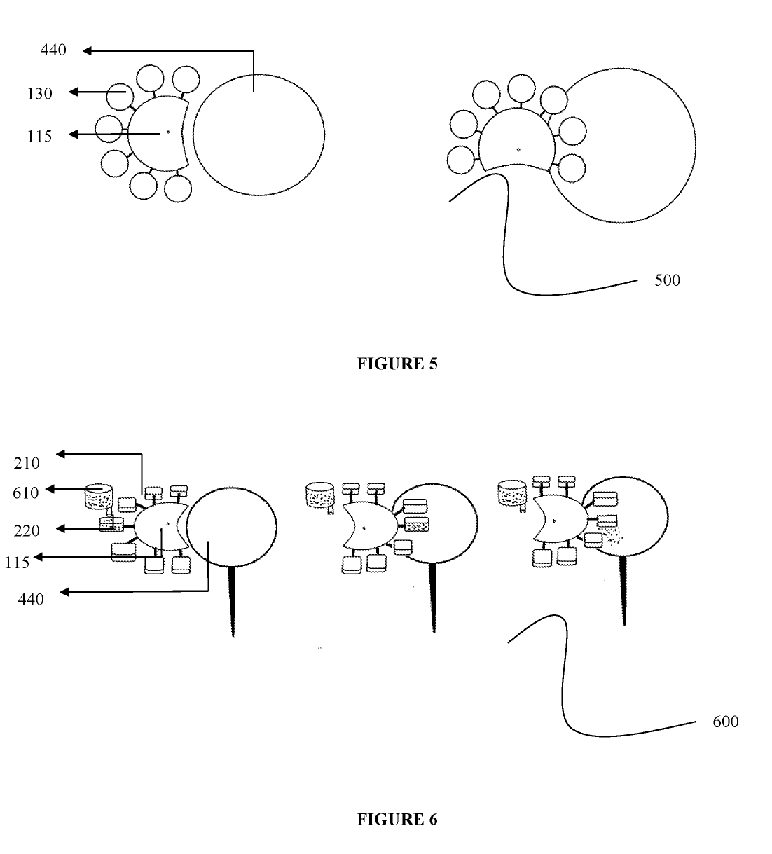

FIG. 5 illustrates the exemplary embodiment of the rotation of the carousel, wherein the said carousel 115 rotates from its initial position and places the said rotating arm above the cooking utensil 440 and dispenses the ingredients in the said canister 130 and into the cooking utensil 440 achieved by rotation of the arm and the motor 215.

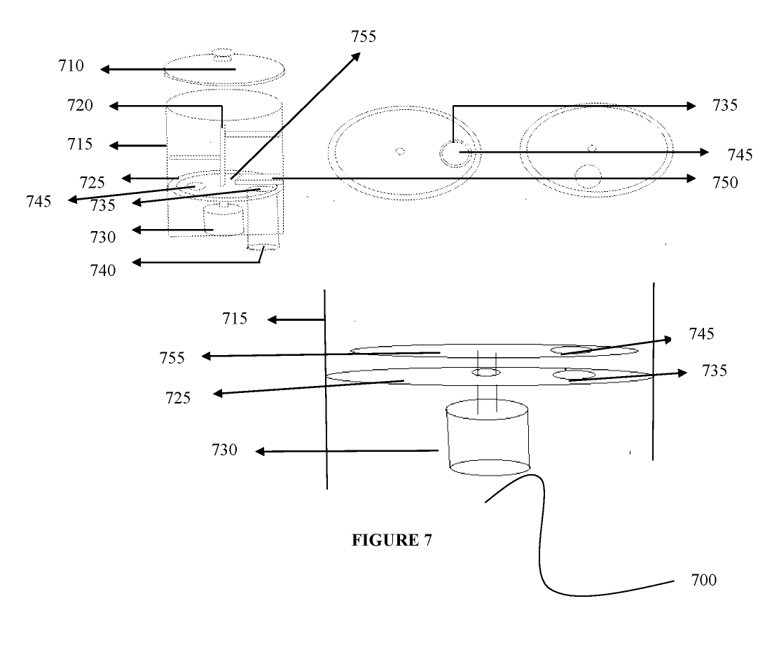

FIG. 6 illustrates the exemplary embodiment of the dry material, preferably spices dispensing container 600 comprising of dry material dispensing container 610 which holds the dry material. The canister 130 is placed below the dry material dispensing container 610. The carousel 115 rotates on its axis and places the canister 130 above the cooking utensil 440. The rotating arm 210 attached to the canister 130 rotates and dispenses the dry material in the cooking utensil 440.

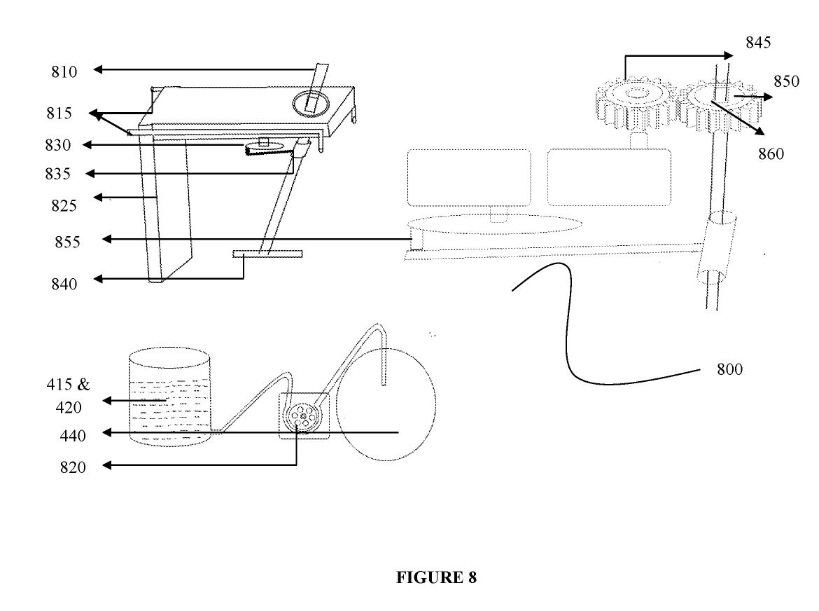

FIG. 7 illustrates the exemplary embodiment of the spice dispenser 700 which comprises of a lid 710 and a cylindrical body 715. The cylindrical body 715 comprises of a rotating stirrer 720 for agitating the dry material inside the container thereby, preventing clogging and formation of lumps and a partition 725 for housing the motor 730 below. The partition 725 is provided with a hole 735 and a circular cylindrical tube 740 attached with the said hole 735, whereby the dry material is dispensed out of the container through the said tube 740. The said partition 725 functions as a separator for separating the dry material from the motor 730 as well as provides a partition for housing the sensors, wires and any other electronics separately.

The spice dispenser 700 further comprises of a circular disc 755 attached to the motor 730, wherein the said circular disc comprises of a hole 745 in concentric alignment with the partition hole 735 whereby, the materials are dispensed through the cylindrical tube 740 out of the container. The said motor 730 rotates the circular disc 755 which gathers the dry material and dispenses it through the said tube 740 out of the container, when the circular disc hole 745 aligns with the partition hole 735.

The amount of dry material discharged through the said tube 740 is controlled by a stopper 750 which covers the partition hole 735 and is aligned above it. The said stopper 750, thus prevents the entire contents from being dispensed, when the said circular disc hole 745 aligns with the partition hole 735.

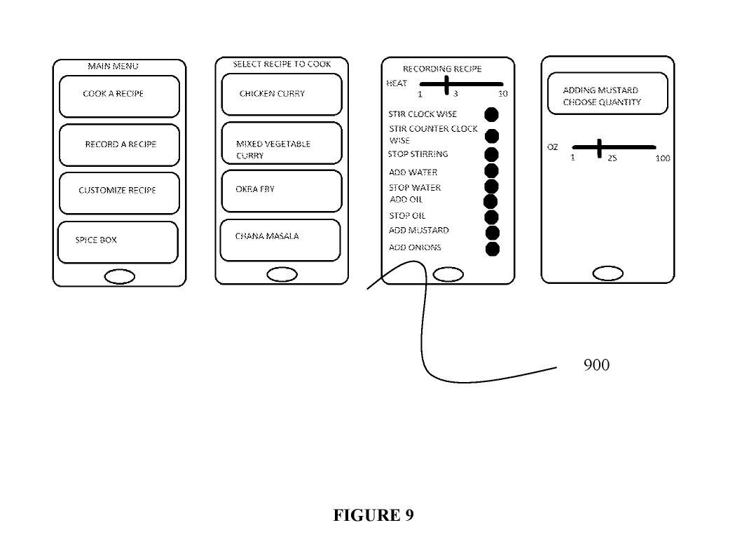

FIG. 8 illustrates the exemplary embodiment of the integrated stirring and liquid dispensing apparatus 800, wherein the said apparatus comprises of a stirring handle or a stirring member 810 and a tube 815 for dispensing the liquid material into the cooking utensil from the top. A peristaltic pump 820 pumps out the liquid from the liquid reservoir 415 and 420 into the cooking utensil 440. Furthermore, the said apparatus comprises of a stirring stand which holds the stirring apparatus and the liquid dispensing tubes 815 which is attached to the base of the said cooking apparatus.

Also included in the apparatus of the present invention is a crank shaft mechanism 855 which is driven by a motor 830 and is attached to a cylindrical object 835 through which the stirring handle 810 is passed through, whereby the ingredients are stirred in the cooking utensil 440 in planetary motion and back and forth motion. The stirring handle 810 further comprises of a stirring paddle 840 for stirring the ingredients in the said cooking utensil 440.

FIG. 8 further illustrates the motor arrangement in the said stirring apparatus 800. The motor which drives the crank shaft mechanism 855 is a gear motor which is operated independently to move or rotate the stirring handle. The said gear motor further rotates a gear 845 which in turn rotates another gear 850 comprising of a rectangular cut out 860 for allowing the stirring handle or stirring member 810 to easily pass through which agitates and mixes the ingredients in the cooking utensil 440.

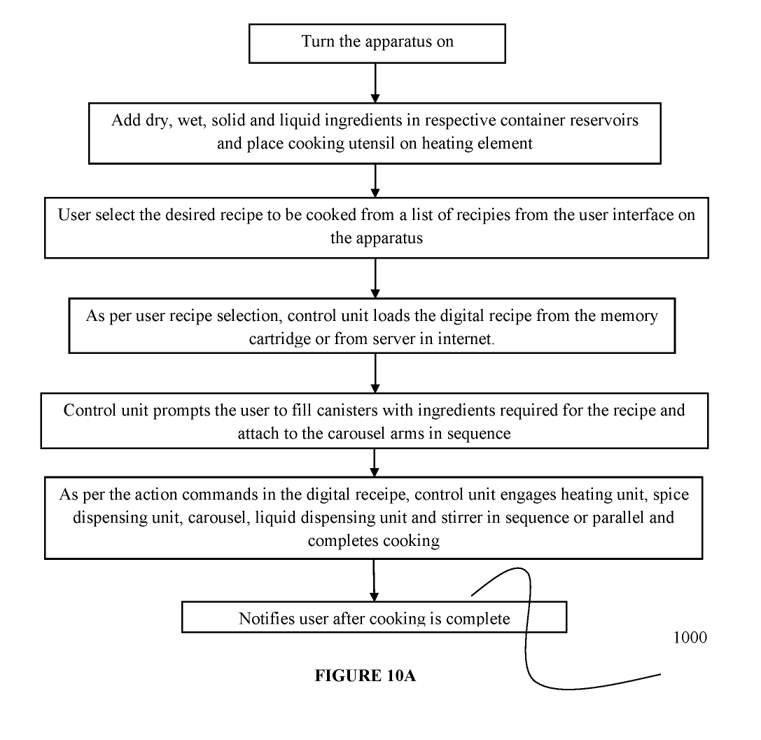

FIG. 9 illustrates an exemplary embodiment of the user interface screen 900 which is displayed in the touch screen interface. The said user interface screen provides the options to use the apparatus for cooking a recipe, recording a recipe, customizing an existing recipe according to the user preference.

Further, provision for adjusting the heat settings, selecting the quantity and type of ingredients, performing other functions viz. starting stirring actions, pumping liquid ingredients and dispensing dry ingredients etc. are included in the interface from which the user can choose.

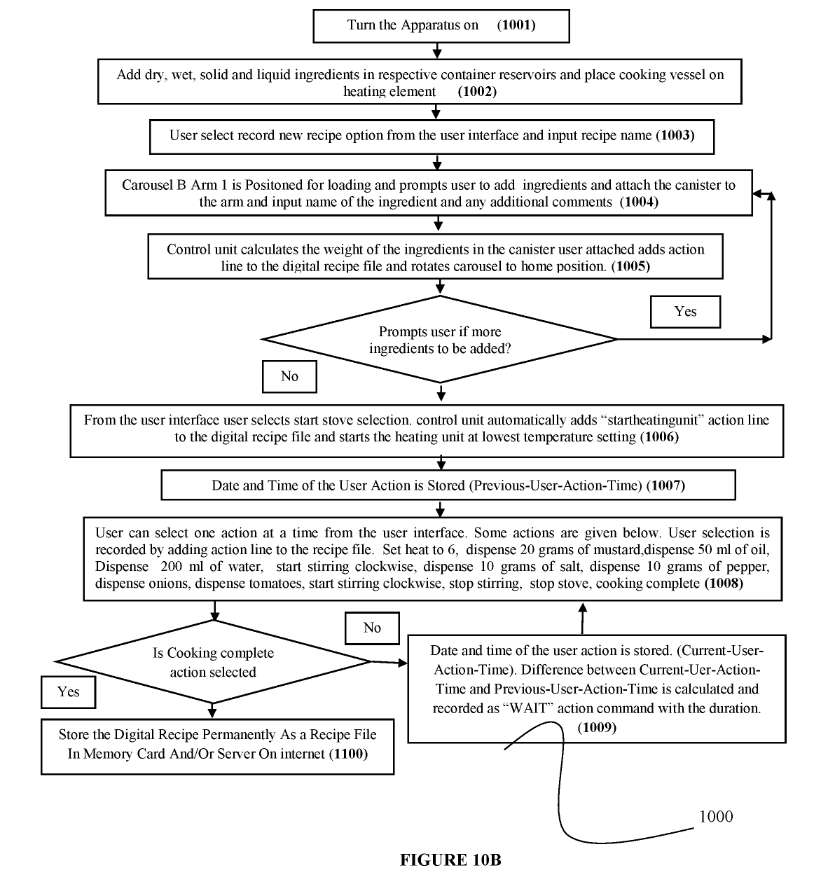

FIG. 10A illustrates the process of working of the apparatus of the present invention as under:
Turning on the apparatus and filling the dry and wet container reservoirs with solid and liquid ingredients respectively.
Selecting the desired recipe to be cooked from a list of recipes from the user interface on the apparatus by the user.
Upon selection of the particular recipe by the user, loading of the digital recipe from the memory cartridge from the server in the internet by the control unit of the apparatus.
Prompting the user by the control unit for filling the canisters with the specific ingredients required for the recipe and attaching the canisters to the carousel arm in sequence.
Engaging the heating unit, spice dispensing unit, carousel, the liquid dispensing unit and stirrer in sequence or parallel according to the action commands in the digital recipe, for completion of the cooking.
Notifying the user upon completion of the cooking.

FIG. 10B is an example of recording the cooking sequence of the apparatus upon selection of a recipe from the user interface of the apparatus of the present invention.

### EXAMPLE WITH REFERENCE TO FIG. 10B:

Turning on the apparatus;
Adding dry, wet, solid and liquid ingredients in respective container reservoirs and placing the cooking vessel on the heating element;
Selection of recording a new recipe option from the user interface and inputting the recipe name;
Positioning the carousel B, Arm 1, for loading and prompting the user to add ingredients and attach the canister to the arm and inputting the name of the ingredient and any additional comments;
Calculating the weight of the ingredients in the canister by the control unit attached by the user and adding the action line to the digital recipe file and rotating the carousel to the home position.
Prompting the user for more ingredient requirement. If the answer is ‘YES’, step 1004/1005 is repeated again and if the answer is ‘NO’ it continues to the next step of 1006, wherein, the user, from the user interface selects ‘START STOVE SELECTION’. The control unit automatically adds “START HEATING UNIT” action line to the digital recipe file and starts the heating unit at the lowest temperature setting;
The actions selected by the user from the user interface must be one action at a time followed by the next action. These actions are recorded in the recipe file which has been selected and named by the user in STEP 1003. Some example steps are: setting heating to 6 - - - dispensing 20 grams of mustard dispensing 50 ml of oil - - - dispensing 200 ml of water - - - start stirring clockwise - - - dispensing 10 grams of salt - - - dispensing 10 grams of pepper - - - dispensing onions - - - dispensing - - - tomatoes - - - start stirring clockwise - - - stop stirring - - - stop stove - - - cooking complete.
If the cooking is complete the user is prompted for ‘ÝES’ or ‘NO’. If the answer is ‘YES’, the digital recipe is permanently stored as a recipe in the memory card and/or server on internet.
If in the above step the answer selected is ‘NO’, the date and time of the user action is stored. (Current-User-Action-Time). The difference between Current-User-Action-Time and Previous-User-Action-Time is calculated and recorded as “WAIT” action command with the duration and STEP 1009 is repeated.

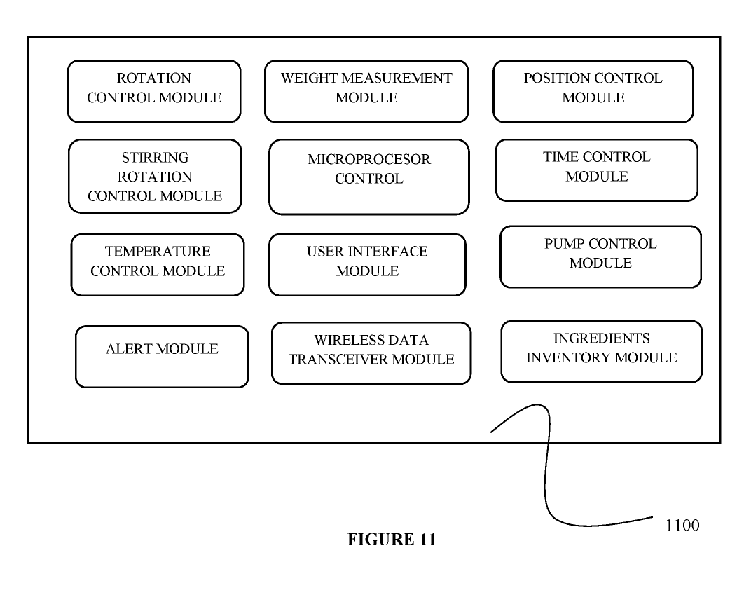

FIG. 11 is an exemplary embodiment of the control unit of the single compact robotic food making apparatus.

TABLE 1
illustrates the Sample Digital Recipe

| SEQUENCEID | ACTION | NUMBER | UNIT | COMMENTS |
|---|---|---|---|---|
| 0001 | LOADCARB1 | 100 | GRAMS | ROTATE CAROUSEL B TO POSITION ARM 1 TO LOADING |
| | | | | POSITON AND PROMPT USER TO LOAD 100 GRAMS |
| | | | | CUT ONIONS IN CANISTER AND ATTACH TO THE ARM |
| 0002 | LOADCARB2 | 150 | GRAMS | ROTATE CAROUSEL B TO POSITION ARM 2 TO LOADING |
| | | | | POSITON AND PROMPT USER TO LOAD 150 GRAMS |
| | | | | CUT TOMATOES IN CANISTER AND ATTACH TO THE ARM |
| 0003 | LOADCARB3 | 200 | GRAMS | ROTATE CAROUSEL B TO POSITION ARM 3 TOLOADING |
| | | | | POSITON AND PROMPT USER TO LOAD 200 GRAMS CUT |
| | | | | CAULIFLOWER IN CANISTER AND ATTACH TO THE ARM |
| 0004 | LOADCARB4 | 200 | GRAMS | ROTATE CAROUSEL B TO POSITION ARM 4 TO LOADING |
| | | | | POSITON AND PROMPT USER TO LOAD 200 GRAMS CUT POTATO |
| | | | | IN CANISTER AND ATTACH TO THE ARM |
| 0005 | LOADCARA1 | 50 | GRAMS | ROTATE CAROUSEL A TO POSITION ARM 1 TO LOADING |
| | | | | POSITON AND PROMPT USER TO LOAD 50 GRAMS OF GINGER |
| | | | | GARLIC PASTE CANISTER AND ATTACH TO THE ARM |
| 0006 | STARTHEATINGUNIT | 1 | NULL | START HEAT UNIT AT LOW HEAT SETTING 140 F. |
| 0007 | SETTEMPERATURE | 3 | NULL | SET TEMPERATURE OF HEATING UNIT TO 2 |
| 0008 | WAIT | 90 | NULL | WAIT FOR 90 SECONDS |
| 0009 | DISPENSELIQ2 | 50 | ML | DISPENSE OIL 50 ML |
| 0010 | WAIT | 120 | NULL | WAIT FOR 100 SECONDS |
| 0011 | DISPENSESB1 | 30 | GRAMS | DISPENSE 30 GRAMS MUSTARD SEEDS FROM SPICE BOX 1. |
| 0012 | STARTSTIRCLOCK | NULL | NULL | STIRRING IN CLOCK WISE DIRECTION |
| 0013 | WAIT | 45 | NULL | WAIT FOR 45 SECONDS |
| 0014 | STARTSTIRCTRCLOCK | NULL | NULL | SIRRING IN COUNTER CLOCK WISEDIRECTION |
| 0015 | WAIT | 45 | NULL | WAIT FOR 45 SECONDS |
| 0016 | STOPSTIRRING | NULL | NULL | STOPS STIRRER |
| 0017 | DISPENSECARB1 | NULL | NULL | DISPENSE ONIONS IN CAROUSEL B ARM 1 |
| 0018 | SETHEATUNITTEMP | 6 | NULL | SET TEMPERATURE OF HEATING UNIT TO 6 |
| 0019 | DISPENSECARA1 | NULL | NULL | DISPENSE GINGER GARLIC PASTE IN CAROUSEL A ARM 2 |
| 0086 | STOPSTIRRING | NULL | NULL | STOPS STIRRER |
| 0087 | STOPHEATINGUNIT | NULL | NULL | TURN OFF HEATING UNIT |

TABLE 2
illustrates the sample list of action commands

| NO. | ACTION COMMAND | DESCRIPTION |
|---|---|---|
| 1 | STARTHEATINGUNIT | STARTS THE HEATING UNIT AND SET IT TO |
| | | LOWEST TEMPERATURE SETTING. |
| 2 | SETTEMPEPRATURE N | SET HEATING UNIT TEMPERATURE TO SCALE |
| | | OF 1 TO 10. 1 BEING THE LOWEST AND 10 |
| | | BEING THE HEIGHEST. HEATING UNIT WILL |
| | | BE CONTINUOUSLY MONITERED AND THIS |
| | | SCALE AND IS MAINTAINED UNTILL |
| | | ANOTHER COMMAND OVERRIDES TO |
| | | INCREASE OR DECREASE OR STOPS THE |
| | | HEATING UNIT |
| 3 | STOPHEATINGUNIT | STOPS THE HEATING UNIT |
| 4 | WAIT N | CONTROL UNIT WAITS FOR “N” SECONDS |
| | | TO PROCESS NEXT ACTION COMMAND. |
| 5 | STARTSTIRCLOCK | STARTS STIRRING IN CLOCKWISE DIRECTION. |
| | | UNTIL ANOTHER STIRRING COMMAND |
| | | OVERRISED STIRRING ACTITON IN THIS |
| | | DIRECTION CONTINUES. |
| 6 | STOPSTRRING | CLOCKWISE OR COUNTER CLOCKWISE |
| | | STIRRING ACTION WILL STOP. |
| 7 | LOADCARXN | ROTATES CAROUSEL X AND POSITION |
| | | CAROUSEL X ARM N FOR ATTACHING THE |
| | | CANISTER WITH INGREDIENTS TO THE ARM |
| | | EASILY |
| 8 | DISPENSECARXN | ROTATES CAROUSEL X AND POSITION ARM N |
| | | RIGHT ABOVE THE COOKING VESSEL AND |
| | | DISPENSE THE CONTENTS OF THE CANISTER |
| | | INTO THE COOKING VESSEL BY ROATING THE |
| | | CANISTER ATTACHED TO THE ARM |
| 9 | DISPENSELIQA N ML | DISPENSES LIQUID FROM LIQUID RESERVOIR |
| | | A “N” ML INTO THE COOKING POT. |
| 10 | DISPENSESBX N | DISPENSE N GRAMS OF SPICES FROM |
| | GRAMS | SPICEBOX NUMBER “X” INTO THE CAROUSEL |
| | | CANISTER AFTER DISPENSING CAROUSEL |
| | | CANISTER ROTATES THE ARM RIGHT ABOVE |
| | | THE COOKING POT AND DISPENSES SPICES |
| | | COLLECTED FROM SPICE BOX INTO THE |
| | | COOKING POT. |

The above described apparatus is only exemplary, and the said apparatus can be applied to any material or metal of different forms, shapes and sizes.

The materials in the above apparatus can be any one of the following: natural material such as any type of wood, any form of metal, composite materials made out of fiber and resin combinations. Fibers can be natural or synthetic—more particularly glass fiber, carbon fiber, aramid fiber, boron fiber, nylon fiber, jute fiber, sisal hemp fiber along with any of the resins including isophthalic or bisphenol or Vinyl or Vinyl superior; Polymers either thermoplastic or thermoset and more particularly from any one of U-poly vinyl chloride, ABS, polyethylene, PET, polyoxy methylene, polytetrafluoroethylene, poly vinylidene fluoride or Bakelite.

The examples described above in association with the figures are only exemplary and the robotic cooking device can be custom made. The device can be applied to designs and sizes differing from what are shown in the figures.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodology, but one of ordinary skill in the art may recognize that many further combinations and permutations are possible. Accordingly, the novel architecture is intended to embrace all such alterations, modifications and variations that fall within the spirit and scope of the appended claims.

Without further description, it is believed that one of ordinary skill in the art can, using the preceding description and the illustrative examples, make and utilize the present invention and practice the claimed methods. It should be understood that the foregoing discussion and examples merely present a detailed description of certain preferred embodiments. It will be apparent to those of ordinary skill in the art that various modifications and equivalents can be made without departing from the spirit and scope of the invention.

What is claimed is:

1. A single compact robotic food making apparatus comprising:
at least one dry dispensing unit;
at least one liquid dispensing unit;
at least one carousel unit;
a stirring unit comprising a stirring member;
a heating unit comprising a heating element and a plurality of sensors;
a processing module;
a user interface screen;
wherein,
the said dry dispenser unit, the said liquid dispensing unit and the said carousel unit the said heating unit, and the said stirring unit are connected with the said processing module.

2. A single compact robotic food making apparatus of claim 1, wherein, the said carousel unit further comprises:
a rotating arm;
a plurality of canisters;
a motor for rotating the said rotating arm; and
a plurality of sensors.

3. A single compact robotic food making apparatus of claim 1, wherein, the said stirring unit comprises of a stirring member, which rotates in an anticlockwise and clockwise direction.

4. A single compact robotic food making apparatus of claim 1, wherein, the sensor of the said heating unit is for detecting the presence of a cooking utensil on it.

5. A single compact robotic food making apparatus of claim 1, wherein, the sensor of the said heating unit is a temperature sensor for gauging the temperature of the said cooking utensil.

6. A single compact robotic food making apparatus of claim 1, wherein, the said sensor of the said dry dispensing unit is for measuring the weight of the material affixed in the in the said rotating arm of the said carousel unit.

7. A single compact robotic food making apparatus of claim 2, wherein, the said sensor of the carousel unit is for detecting the position of the rotating arm.

8. A single compact robotic food making apparatus of claim 1, wherein the said processor module is configured to automatically calculate the quantity of dry and liquid material needed to dispense for the recipe selected by the user.

9. A single compact robotic food making apparatus of claim 1, wherein the said processor module detects the presence of cooking utensil on the said heating unit and controls the heating unit temperature.

10. A single compact robotic food making apparatus of claim 1, wherein the said processor module controls the stirrer in clock wise and counter clock wise direction and the rotation of carousel bidirectionally.

11. A single compact robotic food making apparatus of claim 1, wherein the said processor module controls multiple rotational movements of rotating arms.

12. A single compact robotic food making apparatus of claim 1, wherein the said processor module sends and receives data wirelessly and communicates with wireless device by means of transceiver and stores the said data in the memory card.
